(19) United States
(12) Patent Application Publication
(10) Pub. No.: US 2024/0253148 A1
(43) Pub. Date: Aug. 1, 2024

(54) WELDING METHODS FOR JOINING LIGHT METAL AND HIGH-STRENGTH STEEL USING SOLID STATE AND RESISTANCE SPOT WELDING PROCESSES

(71) Applicant: Ohio State Innovation Foundation, Columbus, OH (US)

(72) Inventors: Wei Zhang, Dublin, OH (US); Ying Lu, Columbus, OH (US); Luke Walker, Columbus, OH (US); Menachem Kimchi, Westville, OH (US)

(21) Appl. No.: 18/597,335

(22) Filed: Mar. 6, 2024

Related U.S. Application Data
(63) Continuation of application No. 16/508,669, filed on Jul. 11, 2019, now abandoned.
Application No. 16/508,669 is a continuation-in-part of application No. 16/006,903, filed on Jun. 13, 2018.
(60) Provisional application No. 62/519,300, filed on Jun. 14, 2017.

(51) Int. Cl. B23K 11/20; B23K 11/11; B23K 103/04; B23K 103/08; B23K 103/10; B23K 103/14; B23K 103/20; B23K 103/24

(52) U.S. Cl. CPC B23K 11/20; B23K 11/115; B23K 2103/04; B23K 2103/10; B23K 2103/14; B23K 2103/15; B23K 2103/20; B23K 2103/24

(57) ABSTRACT

An example method for joining metals is described herein. The method can include forming an intermediate joint between a light metal member and a metal insert, where the intermediate joint is formed using a solid state welding process. The method can also include forming a primary joint between the light metal member and a high strength steel member, where the primary joint is formed using a welding process that produces coalescence at a temperature above the melting point of the light metal member and/or the high-strength steel member.

### CROSS-REFERENCE TO RELATED APPLICATIONS

This application is a continuation of U.S. patent application Ser. No. 16/508,669, filed on Jul. 11, 2019, and entitled “WELDING METHODS FOR JOINING LIGHT METAL AND HIGH-STRENGTH STEEL USING SOLID STATE AND RESISTANCE SPOT WELDING PROCESSES” which is a continuation-in-part of U.S. patent application Ser. No. 16/006,903, filed on Jun. 13, 2018, and entitled “WELDING METHODS INCLUDING FORMATION OF AN INTERMEDIATE JOINT USING A SOLID STATE WELDING PROCESS,” which claims the benefit of U.S. provisional patent application No. 62/519,300, filed on Jun. 14, 2017, and entitled “WELDING METHODS INCLUDING FORMATION OF AN INTERMEDIATE JOINT USING A SOLID STATE WELDING PROCESS,” the disclosures of which are expressly incorporated herein by reference in their entireties.

### BACKGROUND

With the ever-increasing demand of weight reduction and crashworthiness improvement of vehicle, multi-materials design with ultrahigh-strength steels (UHSS), such as hot stamped boron steel USIBOR 1500 of ARCELORMITTAL S.A. of Luxembourg City, Luxembourg, and light metals, such as aluminum alloys (Al), are being utilized extensively. Resistance spot welding (RSW) of Al to steel is challenging due to the formation of thick intermetallic compounds (IMCs) and welding defects, such as shrinkage voids and solidification cracking. S. Fukumoto, H. Tsubakino, K. Okita, M. Aritoshi, T. Tomita, Scr. Mater. 42 (2000) 807-812; T. Tanaka, T. Morishige, T. Hirata, Scr. Mater. 61 (2009) 756-759. To reduce heat input, solid-state joining methods, such as friction welding, ultrasonic spot welding, friction stir spot welding have attracted attention. S. Fukumoto, H. Tsubakino, K. Okita, M. Aritoshi, T. Tomita, Scr. Mater. 42 (2000) 807-812; H. T. Fujii, Y. Goto, Y. S. Sato, H. Kokawa, Scr. Mater. 116 (2016) 135-138; T. Tanaka, T. Morishige, T. Hirata, Scr. Mater. 61 (2009) 756-759.

To join aluminum alloy to coated hot stamped boron steel in press hardened state (e.g., USIBOR 1500), is even more difficult due to the ultrahigh strength of the steel (e.g., 1500 MPa) as well as the tenacious surface coating. Silva et al. and Ding et al. have joined aluminum to AlSi coated boron steel by using friction stir spot welding (FSSW) or refill FSSW. A.A.M. da Silva, E. Aldanondo, P. Alvarez, E. Arruti, A. Echeverría, Sci. Technol. Weld. Join. 15 (2010) 682-687; Y. Ding, Z. Shen, A.P. Gerlich, J. Manuf. Process. 30 (2017) 353-360. However, the boron steels used in their studies were in as-received condition prior to press hardening with low ultimate tensile strength of 400-600 MPa. There are limited reports of joining of aluminum to coated hot stamped boron steel in the press-hardened state with an ultimate tensile strength of 1500 MPa. Oliveira et al. have done dissimilar metal joining of 2-mm-thick AA6005-T5 to 1.4-mm-thick Usibor 1500 by a two-step joining process. Two sheets of Usibor 1500 were first joined by resistance spot welding and then the 2T stack of steels was joined to AA6005 by friction element welding with consumable element made of a creep resistant Cr-Mo steel with Zn-Ni coating. J. P. Oliveira, K. Ponder, E. Brizes, T. Abke, A. J. Ramirez, J. Mater. Process. Technol. (2019). It is noted that the friction element welding process is a relatively new technology to the automotive industry and thus much less available in the automotive assembly line when compared to the resistance spot welding process.

### SUMMARY

Described herein are methods for metal joining that make use of the existing assembly line infrastructure. The methods can be used to join dissimilar metals (e.g., light metals such as aluminum to ultrahigh-strength steels such as USIBOR 1500). The current de facto process for assembling automotive body structures is resistance spot welding (RSW). For example, a passenger car body structure typically contains 3000 to 5000 spot welds. However, dissimilar joining of aluminum to an ultrahigh-strength steel such as USIBOR 1500 using RSW is difficult as the joint is brittle due to the severe formation of IMCs. As described below, ultrasonic plus resistance spot welding (U+RSW) can enable the direct joining of aluminum to ultrahigh-strength steel using the existing RSW machines.

An example method for joining metals is described herein. The method can include forming an intermediate joint between a light metal member and a metal insert, where the intermediate joint is formed using a solid state welding process. The method can also include forming a primary joint between the light metal member and a high-strength steel member, where the primary joint is formed using a welding process that produces coalescence at a temperature above the melting point of the light metal member and/or the high-strength steel member.

In some implementations, the high-strength steel member can be aluminized steel. In some implementations, the high-strength steel can include a zinc or an aluminum-silicon alloy coating. In some implementations, the high-strength steel can be press hardened boron steel.

Alternatively or additionally, the light metal member can be aluminum (Al) or an aluminum alloy, magnesium (Mg) or a magnesium alloy, or titanium (Ti) or a titanium alloy.

Alternatively or additionally, the metal insert can have a thickness greater than 0.125 millimeter (mm). Optionally, the metal insert can have a thickness of about 0.25 mm.

Alternatively or additionally, the primary joint can be formed to at least partially overlap with the intermediate joint. Alternatively or additionally, the intermediate joint can be selectively formed at a desired location of the primary joint before forming the primary joint.

Alternatively or additionally, the intermediate joint can be a metallurgical bond. In some implementations, the solid state welding process used to form the intermediate joint can roughen a surface of the metal insert.

Alternatively or additionally, the solid state welding process used to form the intermediate joint can be an ultrasonic welding process or an impact welding process. Alternatively or additionally, the welding process used to form the primary joint can be resistance welding, projection welding, or a capacitive discharge welding process. For example, in some implementations, the solid state welding process used to form the intermediate joint can be ultrasonic spot welding, and the welding process used to form the primary joint can be resistance spot welding.

Alternatively or additionally, a thickness of intermetallic compounds at the interface between the light metal and high-strength steel members after formation of the primary joint is sufficiently thin to avoid a detrimental effect on mechanical properties of the primary joint.

Alternatively or additionally, a strength of the primary joint is greater than a minimum required by a relevant industry standard.

Alternatively or additionally, the method can include providing a sealant layer between the light metal member and the metal insert before forming the intermediate joint. Optionally, the sealant layer can be an adhesive.

Alternatively or additionally, the metal insert can be a high melting point metal including, but not limited to, stainless steel, low alloy steel, high entropy alloy, or other alloy that is metallurgically compatible with high-strength steel member.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method for joining metals using ultrasonic plus resistance spot welding (U+RSW) according to an implementation described herein.

FIG. 2A shows key dimensions measured on the cross section of an example U+RSW joint. FIG. 2B is zoomed in view of box 200 in FIG. 2A. FIG. 2C shows the effect of welding current on the nugget diameter and the bulge height of steel into AA6022.

FIGS. 3A-3D illustrate scanning electron microscope (SEM) characterization of an example Al/ultrahigh-strength steel joint welded by U+RSW according to an implementation described herein. FIG. 3A is a SEM image of the faying interface for Al/stainless steel insert of the U+RSW weld. FIG. 3B is an energy-dispersive X-ray spectroscopy (EDS) element mapping of FIG. 3A. FIG. 3C shows a zoomed in image of a portion of FIG. 3A. FIG. 3D is a graph showing EDS composition profiles along the arrow marked in FIG. 3C. In FIGS. 3A-3D, the welding parameters for the primary joint were: welding current=14 kA, welding time=100 ms, electrode force=4.89 kN.

FIGS. 4A-4D illustrate SEM characterization of an example Al/ultrahigh-strength steel joint welded by direct RSW according to an implementation described herein. Unlike the joint welded by U+RSW shown in FIGS. 3A-3D, this joint of FIGS. 4A-4D was created by simply placing a stainless steel insert between the Al and ultrahigh-strength sheets without producing an intermediate joint prior to RSW. FIG. 4A is SEM image of the faying interface for Al/stainless steel insert of the RSW weld. FIG. 4B is an EDS element mapping of FIG. 4A. FIG. 4C shows a zoomed in image of a portion of FIG. 4A. FIG. 4D is a graph showing EDS composition profiles along the arrow marked in FIG. 4C. Welding parameters used were the same as those in FIGS. 3A-3D.

FIGS. 5A and 5B illustrate the thickness of the continuous layer of the intermetallic components (IMCs) at the Al/steel faying interface for U+RSW and RSW. FIG. 5A illustrates the thickness of the continuous layer 500 of the IMCs at the Al/steel faying interface for U+RSW. FIG. 5B compares the thickness of the continuous layer of the intermetallic components (IMCs) at the Al/steel faying interface for U+RSW versus RSW. Welding parameters used were the same as those in FIGS. 3A-3D.

FIG. 6A illustrates the effect of welding current on the peak strength, fracture energy and failure mode of U+RSW welded dissimilar joints of AA6022 to USIBOR 1500. FIG. 6B illustrates the fracture surface in pullout failure mode at welding currents between 12 kA to 16 kA. The welding time and electrode force for U+RSW were kept as 100 ms and 4.89 kN, respectively.

FIG. 7A illustrates the effect of insert thickness on mechanical property of U+RSW welds where welding current=16 kA. Embedded is the interface microstructure at insert/Usibor 1500 interface when the 0.125-mm-thick SS316 was used as insert. FIG. 7B is a comparison of mechanical property of the U+RSW and RSW welded joints where welding current=14 kA.

FIG. 8 is Table 1, which provides the nominal chemical compositions of base materials and insert (wt. %) for the example materials described with respect to FIG. 1.

FIG. 9A illustrates an example USW machine. FIG. 9B illustrates an example RSW machine.

FIG. 10 is a chart illustrating the load-displacement curve of an example U+RSW joint between an Al sheet and AlSi coated ultrahigh-strength steel USIBOR 1500.

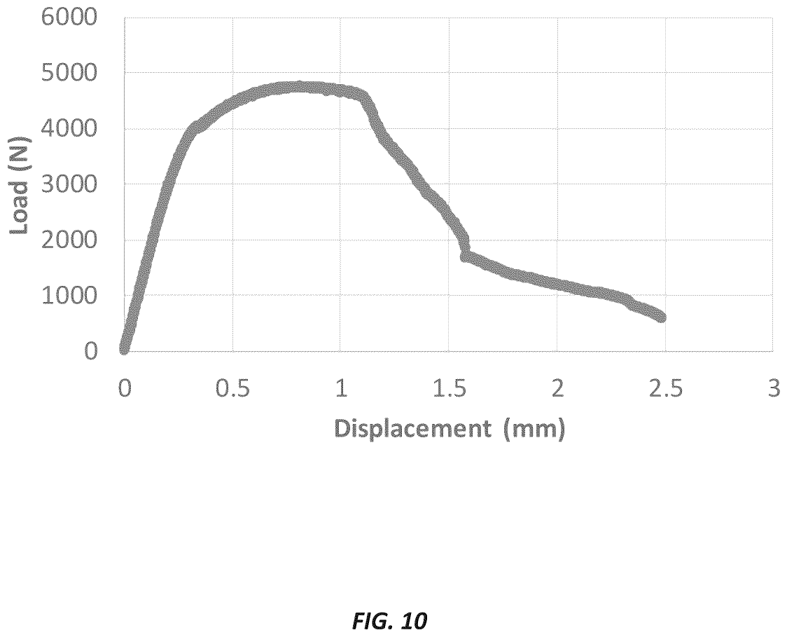

FIG. 11 is a chart illustrating the joint strength in lap-shear tensile testing as a function of welding current used in the second step of U+RSW to create a primary weld, for example, a primary joint as described in Example 2.

FIG. 12 illustrates a button-pull-out failure mode (joint strength=3.4 kN) for a primary weld, for example, a primary joint as described in Example 2.

FIGS. 13A and 13B illustrate the microstructure for a primary weld, for example, a primary joint as described in Example 2. FIG. 13A illustrates IMCs formed at the Al/steel interface after formation of the intermediate joint. FIG. 13B illustrates IMC growth at the Al/steel interface after formation of the primary joint.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for ultrasonic plus resistance spot welding (U+RSW), it will become evident to those skilled in the art that the implementations are not limited thereto, but are applicable for other processes including, but not limited to, ultrasonic plus resistance seam welding. Additionally, the implementations described herein are also applicable to other welding processes, for example, where the intermediate joint is formed using a solid state welding process followed by formation of a primary joint using a welding process producing coalescence.

An example ultrasonic plus resistance spot welding (U+RSW) method for joining first and second structural members is described below. As described herein, the first structural member can be made of a light metal such as aluminum or an aluminum alloy. It should be understood that aluminum alloy 6022-T4 (AA6022-T4) is used only as in example in the implementations described below. This disclosure contemplates that the light metal member can be made of a material other than aluminum or its alloys thereof, including but not limited to, magnesium, magnesium alloy, titanium, or titanium alloy. Additionally, the second structural member can be made of high-strength steel. High-strength steels include, but are not limited to, USIBOR 1500 ultrahigh-strength steel of ARCELORMITTAL S.A. of Luxembourg City, Luxembourg. USIBOR 1500 ultrahigh-strength steel can be used in automotive and aerospace applications. It should be understood that USIBOR 1500 ultrahigh-strength steel is used only as in example in the implementations described below. This disclosure contemplates that the high-strength steel member can be other high-strength steels including, but not limited to, ultrahigh-strength steel, high strength steel coated with zinc (Zn) or an aluminum-silicon (AlSi) alloy coating, hot stamped boron steel, etc. In some implementations, the high-strength steel has a tensile strength of about 1500 MPa or greater. It should be understood that the tensile strength value is provided only as an example. This disclosure contemplates that the high-strength steel can have a tensile strength of between about 780 MPa and 1500 MPa (e.g., 780 MPa, 781 MPa, 782 MPa, . . . , 1498 MPa, 1499 MPa, 1500 MPa) including any range or value therebetween. Additionally, this disclosure contemplates that the high-strength steel be a resistance spot weldable steel with nominal tensile strength greater than 1500 MPa. As described above, joining Al to high-strength steel using RSW processes is challenging due to IMC formation, tenacious coating on the steel surface, and/or welding defects. The U+RSW technique described herein is capable of producing a high strength joint at the interface between a light metal such as Al and ultrahigh-strength steel such as AlSi coated USIBOR 1500. It should be understood that USIBOR 1500 is one of the highest strength steels currently in use, and it has a tenacious AlSi coating. Using the technique described herein, to create a sound joint, the metal insert and the ultrahigh-strength steel (USIBOR 1500) were melted together (e.g., using the RSW process to form the primary joint). On the other side, the metal insert was not melted and only the light metal (Al alloy) was melted during RSW to form the primary joint.

In a first step, the method includes forming an intermediate joint between a first structural member (e.g., a light metal member) and a metal insert. As described herein, the metal insert can be a high melting point metal insert such as stainless steel, low alloy steel, high entropy alloy, or other alloy that is metallurgically compatible with high-strength steel member. The intermediate joint can be a metallurgical bond between the first structural member and the metal insert. The intermediate joint can be formed using a solid state welding process. It should be understood that solid state welding processes produce coalescence below the melting point of the metals. Solid state welding processes are known in the art. For example, solid state welding processes include, but are not limited to, ultrasonic welding or impact welding. In a second step, after forming the intermediate joint using the solid state welding process, the method includes forming a primary joint between the first structural member (e.g., the light metal member to which the metal insert has been welded) and a second structural member (e.g., a high-strength steel member). The primary joint can be formed using a welding process that produces coalescence at a temperature above the melting point of the first structural member and/or the second structural member. Welding processes producing coalescence at a temperature above the melting point of metal(s) are known in the art. For example, such welding processes include, but are not limited to resistance welding, projection welding, or a capacitive discharge welding process. As an example below, an ultrasonic plus resistance spot welding technique is described. This disclosure contemplates that techniques involving other solid state welding processes to form the intermediate joint and/or other welding processes to form the primary joint can be implemented according to this disclosure.

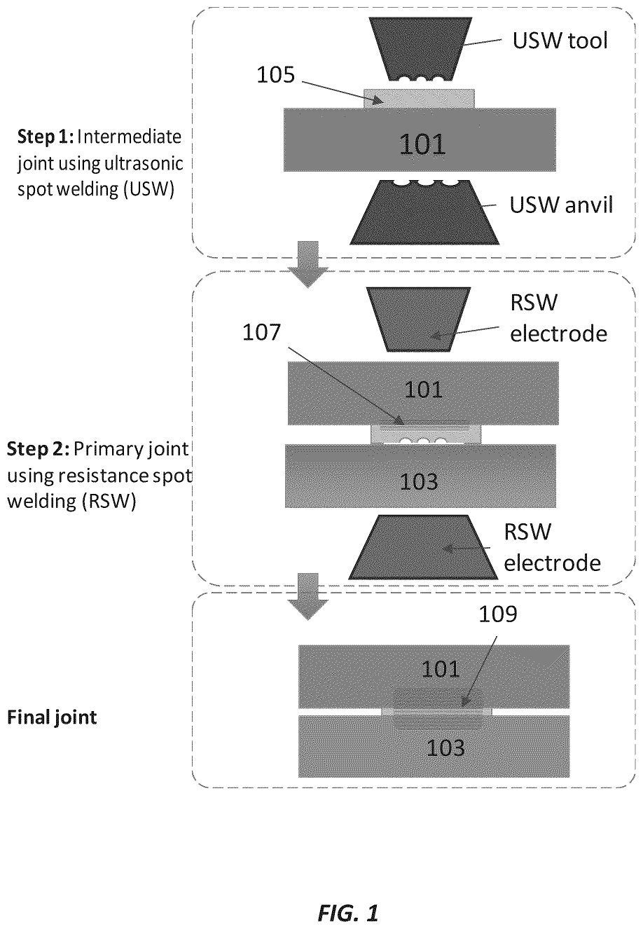

Referring now to FIG. 1, a method for joining metals using ultrasonic plus resistance spot welding (U+RSW) is shown. U+RSW involves two steps, as shown in FIG. 1. U+RSW can be used to join a light metal member 101 and a high-strength steel member 103. In FIG. 1, the light metal member 101 is aluminum alloy 6022-T4. It has a thickness of 1.2 millimeter (mm). In FIG. 1, the high-strength steel member 103 is AlSi coated ultrahigh-strength steel USIBOR 1500 in the press hardened state. It has a thickness of 1.4 mm. It should be understood that the materials and/or thicknesses used for the light metal and high-strength steel members 101, 103 in FIG. 1 are provided only as examples.

Alternatively or additionally, the light metal member 101 and/or the high-strength steel member 103 can include multiple sheets of the similar material. For example, the light metal member 101 can include a plurality of Al alloy sheets (e.g., 2 sheets), and the high-strength steel member 103 can include a plurality of steel sheets (e.g., 2 sheets). It should be understood that the number of sheets are provided only as examples and that this disclosure contemplates using different numbers of sheets with the techniques described herein.

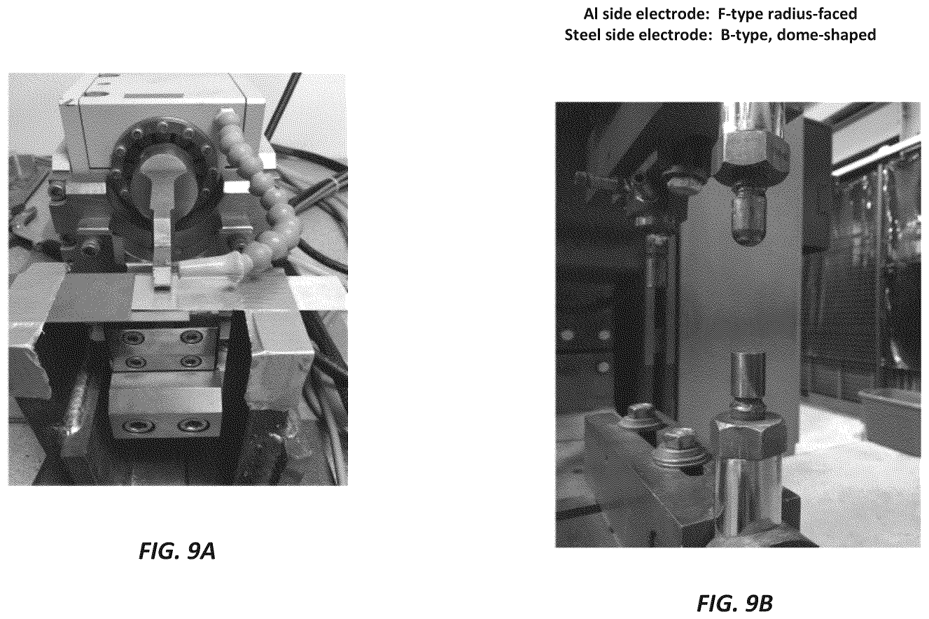

In Step 1, an intermediate joint 107 is formed between the light metal member 101 and a metal insert 105 using ultrasonic spot welding (USW). In FIG. 1, the metal insert 105 is AISI 316 stainless steel and has a thickness of 0.25 mm. As described herein, the metal insert 105 can have a thickness greater than 0.125 mm. In some implementations, the metal insert 105 can have a thickness of about 0.25 mm. It should be understood that the thickness of the metal insert 105 is provided only as an example. This disclosure contemplates that the thickness of the metal insert 105 can be between about 0.15 mm and 0.60 mm (e.g., 0.150 mm, 0.151 mm, 0.152 mm, . . . , 0.598 mm, 0.599 mm, 0.600 mm) including any range or value therebetween. This disclosure contemplates that metal insert thicknesses greater than 0.6 mm may be difficult for ultrasonic spot welding and also would add more weight to the insert. The metal insert 105 can optionally be other materials such as low alloy steels, high entropy alloys, or other alloys that are metallurgically compatible with high-strength steel member 103. It should be understood that the material, stainless steel grade and/or thickness used for the metal insert 105 in FIG. 1 are provided only as examples. USW is a solid state welding process. In other words, the intermediate joint 107 between the light metal member 101 and the metal insert 105 is formed using a solid state welding process (e.g., USW in FIG. 1). In this step, an ultrasonic vibration (e.g., 20-kHz-frequency and 21 microns (m) amplitude) is applied by the USW tool. An example USW machine is shown in FIG. 9A. USW machines are known in the art and therefore not described in further detail herein. The back-and-forth “rubbing” action at the workpieces' interface breaks up and disperses surface oxide, which is a main barrier for bonding. Moreover, the frictional heating softens the joint area to form a sound bond. In FIG. 1, the intermediate joint 107 is a metallurgical bond. Given the short cycle time (e.g., about 0.4 seconds), the IMCs formed at the intermediate joint is minimal. In FIG. 1, the USW tool and anvil have a knurled surface to facilitate the gripping of workpieces. The knurl pattern results in a mirror imprint in the metal insert 105, which facilitates the formation of a primary joint 109 in the subsequent step of the U+RSW process. Optionally, in some implementations, a sealant layer (e.g., an adhesive) can be provided between the light metal member 101 and the metal 105 before forming the intermediate joint 107.

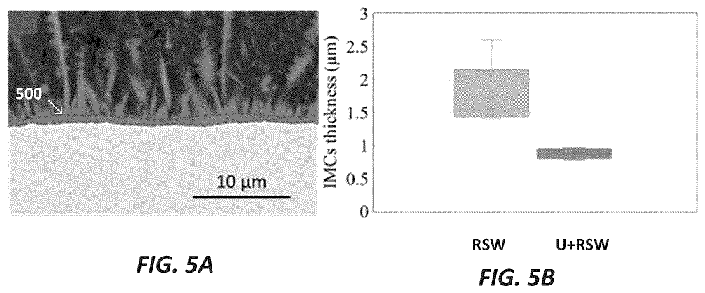

In Step 2, the primary joint 109 is formed between the light metal member 101 and the high-strength steel member 103 using resistance spot welding (RSW). The high-strength steel member 103 is welded to the light metal member 101 through the metal insert 105. RSW is a welding process that produces coalescence above the melting point of the light metal member 101 and the high-strength steel member 103. The “roughened” surface of the metal insert 105 can facilitate the local heat generation to form the primary joint 109. The local regions of metal insert 105 and high-strength steel member 103 in contact with each other are melted and fused together. Such melting may be essential to remove surface coating on the high-strength steel member 103 such as the tenacious AlSi coating on USIBOR 1500. On the other hand, the side of the metal insert 105 that is in contact with the light metal member 101 is not melted. Moreover, as the metal insert 105 and light metal member 101 are already bonded by the intermediate joint 107, an excess growth of IMCs at the Al/steel intermediate joint (i.e., the interface between the light metal member 101 and the metal insert 105) is much less likely to occur for U+RSW than that in RSW of Al to steel directly (i.e., RSW without formation of an intermediate joint). This is shown in FIG. 5B, which illustrates less IMCs thickness for U+RSW than RSW (i.e., 0.87 m for U+RSW versus 1.77 m for RSW in FIG. 5B). The metal insert 105 can be chosen to be metallurgically compatible with the high-strength steel member 103 such that no, or a minimal amount of, brittle IMCs would form at the interface between the metal insert 105 and the high-strength steel member 103 after forming the primary joint 109.

In FIG. 1, the primary joint 109 is formed to at least partially overlap with the intermediate joint 107. Optionally, markings can be provided to align the RSW nugget with USW knurl pattern. In this way, the intermediate joint 107 can be selectively formed at a desired location of the primary joint 109 before forming the primary joint 109. Optionally, a plurality of intermediate joints can be formed using USW at respective locations for a plurality of primary joints to be formed using RSW.

An example RSW machine is shown in FIG. 9B. RSW machines are known in the art and therefore not described in further detail herein.

### EXAMPLES

### Example 1

In the example described below, ultrasonic plus resistance spot welding (U+RSW) has been applied to join 1.2-mm-thick AA6022 (e.g., a light metal member) with 1.4-mm-thick Usibor 1500 ultrahigh strength steel (in press hardened condition) (e.g., a high-strength steel member) with AISI stainless steel 316 as insert (e.g., a metal insert). The interface microstructure and mechanical property of the joint has been characterized and compared to that of direct resistance spot welded joints. The intermetallics are (Fe, Cr, Ni, Mo)₂Al₅adjacent to steel and (Fe, Cr, Ni, Mo)Al₃ adjacent to Al. A high peak load of 5 kN, fracture energy of 2.9 J and pullout failure mode can be obtained with the insert thickness of 0.25 mm for U+RSW welds.

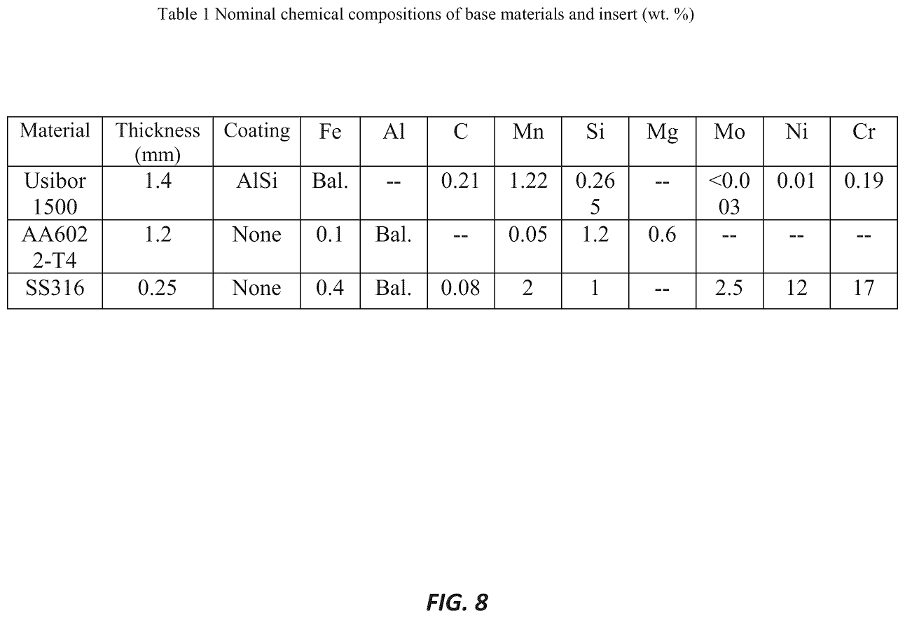

The base materials used in this example were 1.2-mm-thick aluminum alloy AA6022-T4 sheet (e.g., a light metal member), and 1.4-mm-thick AlSi coated hot stamped boron steel, i.e. USIBOR 1500 sheet (e.g., a high-strength steel member). The chemical compositions of the materials are listed in Table 1, which is shown in FIG. 8. The USIBOR 1500 ultrahigh strength steel was welded in the press hardened condition, with the nominal ultimate tensile strength of 1500 MPa. In addition there was no pre-treatment of the surface coating before welding. The samples were 125 mm in length and 38 mm in width. Stainless steel SS316 was used as the insert with the dimension of 25.4 mm×25.4 mm×0.25 mm.

The U+RSW process was conducted in two steps. In the first step, the stainless steel insert was jointed to the AA6022-T4 sheet (referred to below as the “Al sheet”) by ultrasonic spot welding to create an intermediate joint. In the second step, the USIBOR 1500 sheet was welded to the stainless steel side of the intermediate joint to create the primary joint. Specifically, in the first step, a US-3020S Digital Servo Ultrasonic Spot Welder with vibration frequency of 20 kHz was utilized for creating the intermediate joint. The welding parameters for the intermediate joints were as follows: vibration amplitude=21 m, normal force=600 N and welding energy of 500 J. Then, the 1.4-mm-thick USIBOR 1500 sheet was welded to the intermediate joint by a medium frequency direct current (MFDC) resistance spot welder. The electrode force and welding time were kept as 4.89 kN and 100 ms, respectively. The welding current increased from 10 kA to 16 kA. Facing the Al sheet was a F-type radius-faced electrode with a surface diameter of 15.875 mm, while facing the USIBOR 1500 high strength steel sheet was a B-type, dome-shaped electrode with 10 mm face diameter, as shown in FIG. 9B. To study the effect of the insert thickness on the joint strength, U+RSW with 0.125-mm-thick SS316 were performed. For comparison with U+RSW, RSW of an AA6022 sheet to USIBOR 1500 high strength steel with a simply-placed 0.25-mm-thick SS316 insert was also conducted.

Joint strengths of the spot welds were evaluated by quasi-static lap-shear tensile testing with a stroke rate of 1 mm/min. The fracture energy was taken as the area under the load-displacement curve up to the peak load. Due to the consistent failure mode and limited by the amount of materials, repeated tests of sample were only performed at the maximum welding current, i.e. 16 kA for U+RSW and 14 kA for RSW. For observation of the IMCs at Al to steel interface, un-etched samples were analyzed in a FEI Apreo scanning electron microscope (SEM) with energy-dispersive X-ray spectroscopy (EDS).

### Results and Discussion

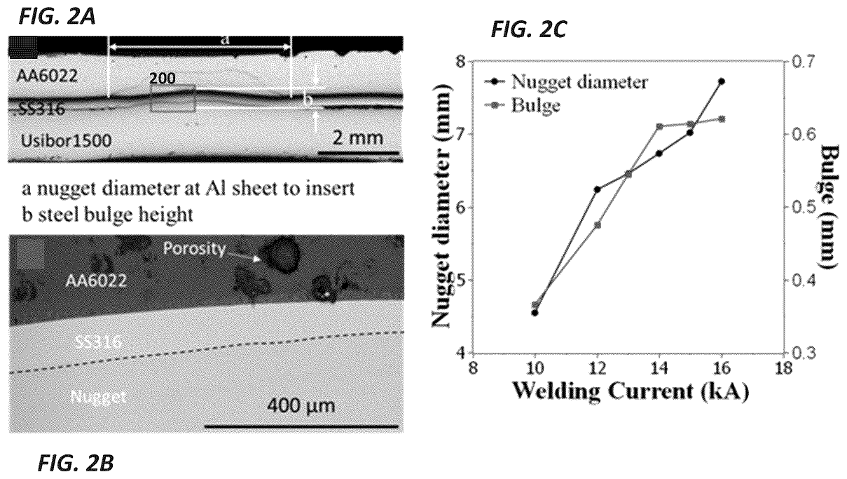

A representative cross-section of the final joint created by U+RSW of AA6022 to USIBOR 1500 ultrahigh strength steel with 0.25-mm-thick SS316 as insert is shown in FIG. 2A. At AA6022/insert interface, it shows a brazing feature which is similar to what has been reported for direct resistance spot welding of Al to steel and U+RSW of aluminum to steel with aluminum alloy as insert. A nugget formed at SS316 insert and USIBOR 1500 steel interface with complete melting and squeezing out of AlSi coating, as is shown in FIG. 2B. Shrinkage voids and porosity were observed near to the weld center. FIG. 2C shows the effect of welding current on the nugget diameter and bulge height of steel into Al. Since the Al/insert interface is the weaker location, the nugget diameter at this interface was measured. The nugget diameter increases with increasing welding current, as expected, and it is 7.7 mm at the welding current of 16 kA. However, the bulge height increases with welding current till 14 kA and it then saturates to approximately 0.61 mm when the welding current is above 14 kA.

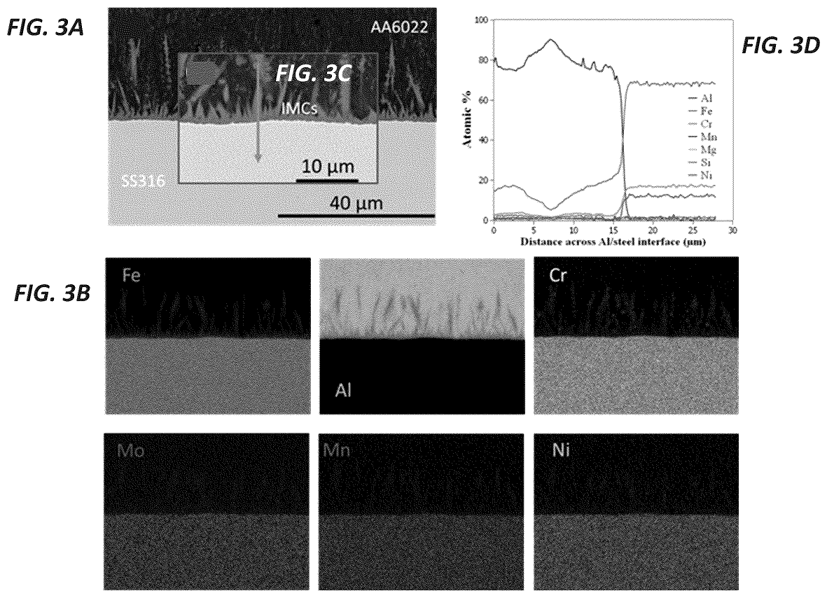

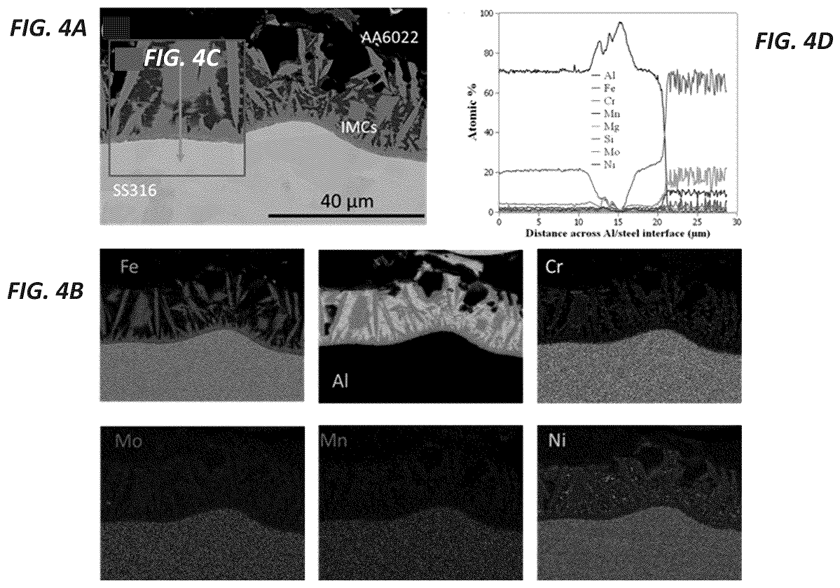

FIG. 3A shows the morphology of the intermetallic compounds (IMCs) formed at center of the Al/insert faying interface during U+RSW. A thin continuous IMCs with a thickness of only 0.87 μm forms near to the steel side with a flat morphology. On AA6022 side, the IMC morphology has an appearance of wide and long needles. Dispersed IMCs also forms in the Al nugget near to the faying interface. The elemental distribution of Fe, Al, Cr, Ni, Mo and Mn are mapped with EDS, as shown in FIG. 3B. A compositional profile along the line across the Al/insert interface shown in FIG. 3C has been plotted in FIG. 3D. The IMCs at the faying interface and dispersed in Al nugget near to the faying interface are enriched in Fe, Al, Cr and Ni. Previous studies by other researchers in the literature have characterized the reaction layer at Al/SS304 interface by transmission electron microscopy (TEM) and have determined the reaction layer consisted of FeAl₃ and Fe₂Al₅ based on the diffraction pattern. Due to dissolution of the alloying elements of stainless steel in liquid aluminum, the IMCs is (Fe, Cr, Ni, Mo)₂Al₅ which is a solid solution based on Fe₂Al₅ adjacent to steel and (Fe, Cr, Ni, Mo)Al₃, a solid solution based on FeAl₃ adjacent to Al. To compare U+RSW welded joints (e.g., FIGS. 2A-3D) with direct resistance spot welding (RSW) of an Al sheet to USIBOR 1500 sheet with a simply-placed insert, the interface microstructure at the center of the weld is shown in FIGS. 4A-4D. As shown in FIGS. 4A-4D, the morphology of the IMCs is similar to that in U+RSW welded joints, which is shown in FIGS. 3A-3D. However, the thickness of the continuous layer near to the steel interface is much thinner for U+RSW and direct RSW for the same welding parameters. In particular, the average thickness of the continuous layer near to the steel interface for U+RSW is 0.87 μm while that for direct RSW is 1.77 μm, as shown in FIGS. 5A and 5B.

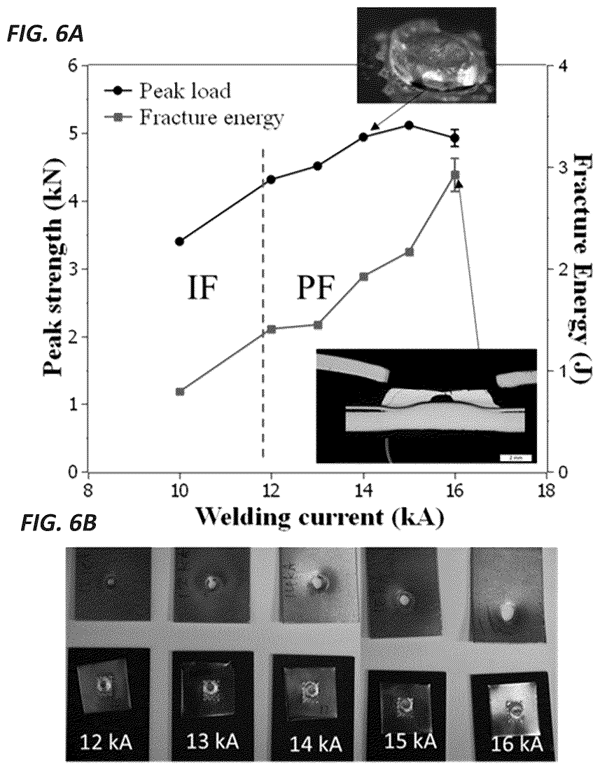

The effect of the welding current on the mechanical properties, i.e. peak load, fracture energy and the failure mode, of the U+RSW welds is shown in FIGS. 6A and 6B. Both the peak load and fracture energy increase with welding current initially. When the welding current is above 14 kA, the peak load tends to saturate at approximately 5 kN. However, the fracture energy continues to increase from 1.9 J to 2.9 J when the welding current increases from 14 kA to 16 kA. There are two competing failure mechanisms: one is the brittle interfacial failure caused by stress concentration at the notch at Al/insert interface; the other is the ductile failure where crack occurs at the heat affected zone (HAZ) or base metal of AA6022. At the welding current of 14 kA and 15 kA, crack initiates at both the notch and the HAZ, as shown in the top fractured surface in FIG. 6A. But the crack propagation at the Al/insert interface stops, which may be due to the curved faying interface resulting from steel bulging and thinner IMCs at the periphery of nugget. Therefore, the relatively lower fracture energy at 14 kA is caused by the combination of brittle and ductile fracture. However, when the welding current increases to 16 kA, complete ductile fracture takes place with no crack initiation at the notch of Al/insert interface, which is shown in the bottom fracture surface embedded in FIG. 6A. As shown in FIG. 6B, pullout failure (PF) mode takes place when the welding current is at or above 12 kA.

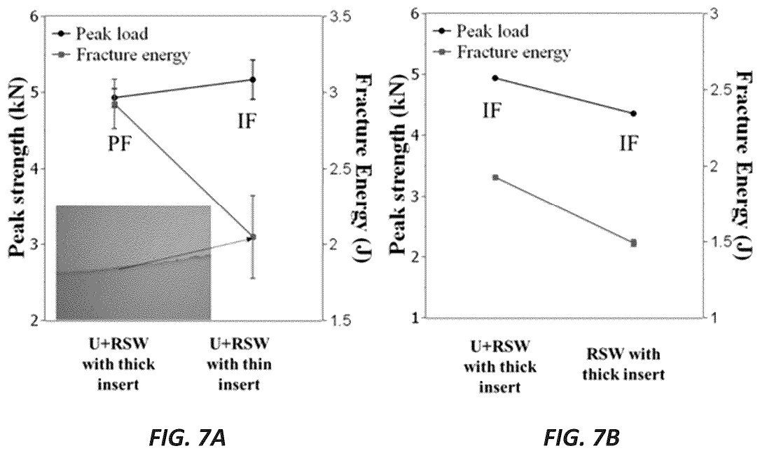

The effect of insert thickness on the mechanical properties and failure mode is shown in FIGS. 7A-7B. The peak load is not affected by the insert thickness, but the fracture energy reduced from 2.9 J to 2 J when the stainless steel insert thickness is reduced from 0.25 mm (e.g. “thick insert” in FIGS. 7A and 7B) to 0.125 mm (e.g. “thin insert” in FIGS. 7A and 7B). Moreover, the failure mode changes from pullout failure (PF) to interfacial fracture (IF) as the insert thickness reduces to 0.125 mm. It is noted that the nugget diameter and bulge height in both cases are 7.8 mm and 0.62 mm respectively, which explains that the peak load is not affected by the insert thickness. However, SS316 insert is bonded to USIBOR high strength steel by the unmelted AlSi coating near to the periphery of the nugget when the thinner insert is used, as shown by the embedded image in FIG. 7A. The unmelted AlSi coating is likely more prone to crack propagation and thus more prone to interfacial failure. Moreover, compared to direct RSW of AA6022 to USIBOR 1500 with a simply-placed 0.25-mm-thick SS316 as insert, U+RSW joints has superior strength, fracture energy and desirable failure mode. One thing needs to be mentioned is that severe expulsion and electrode degradation occurs when the welding current is higher than 14 kA for direct resistance spot welding of Al to steel using the simply-placed insert. Therefore, by reduced contact resistance at Al/insert interface by the formation of the metallurgical bond in U+RSW joints, higher current can be applied which results in larger nugget diameter and superior load bearing capacity.

### Summary and Conclusion

In summary, in the above example, U+RSW has been applied to join 1.2-mm-thick AA6022 to 1.4-mm-thick, AlSi coated USIBOR 1500 ultrahigh strength steel (in press-hardened condition) with SS316 as insert. The IMCs at Al/insert faying interface is (Fe, Cr, Ni, Mo)₂Al₅ adjacent to steel and (Fe, Cr, Ni, Mo)Al₃ adjacent to Al. A high peak strength of 5 kN and fracture energy of 2.9 J can be obtained. Pullout failure mode takes place when the welding current is between 12 kA to 16 kA. For comparison, for resistance spot welding with a simply-placed insert, the peak load and fracture energy is 4.36 kN and 1.5 J with interfacial fracture at welding current of 14 kA.

### Example 2

U.S. patent application Ser. No. 16/006,903, filed on Jun. 13, 2018, the disclosure of which is expressly incorporated herein by reference in its entirety, describes a U+RSW process for joining metals such as dissimilar metals. For example, this process can be used to join first and second structural members, where the first structural member can be steel, titanium (Ti), or nickel (Ni), and the second structural member can be aluminum (Al), magnesium (Mg), copper (Cu), or beryllium (Be). In other implementations, the method can be used to join similar metals. For example, this process can be used to join first and second structural members, where each of the first and second structural members can be aluminum (Al) or magnesium (Mg).

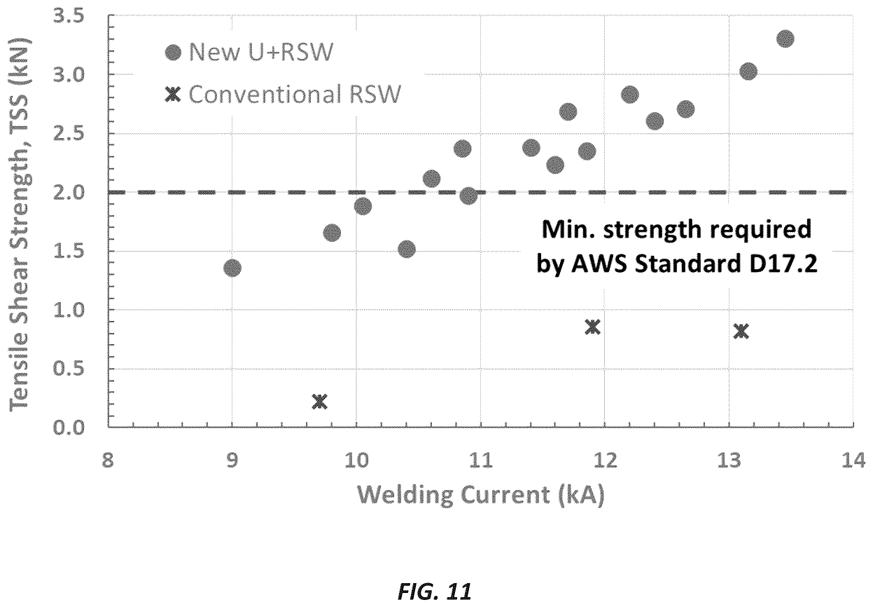

Referring now to FIG. 11, the joint strength in lap-shear tensile testing for the joint created using the U+RSW process described in U.S. patent application Ser. No. 16/006,903 is shown as a function of welding current used in the second step of U+RSW to create the primary weld. As shown in FIG. 11, the joint strength (illustrated with circles or dots in FIG. 11) increases with the weld current, a desirable behavior that is commonly observed in RSW of steel to steel. In other words, higher RSW weld currents yield stronger bonds. Moreover, the joint strength produced by U+RSW (up to 3.4 kilo Newton (kN)) is well above the minimal requirement by relevant industry standard (e.g., 2 kN for 1-mm-thick aluminum alloy 6061-T6). The relevant industry standard (AWS Standard D17.2) is shown by a dotted line. This is not the case for a joint formed by RSW without the intermediate joint, where joint strength is less than the relevant industry standard. Joint strength of a weld formed using the conventional RSW process is illustrated for comparison in FIG. 11. It is well below (e.g., about 1 kN) the relevant industry standard shown in FIG. 11. It should be understood that desired joint strength depends on factors such as types and/or thicknesses of the materials. Additionally, relevant industry standards include, but are not limited to, American Welding Society (AWS) standards or other industry standards such as standards established by other organizations and/or companies (e.g., FORD, GENERAL MOTORS, GENERAL ELECTRIC, etc.). In FIG. 11, when the second step (i.e., formation of the primary weld) is carried out with weld current above about 11 kA, the joint strength exceeds a relevant industry standard (e.g., AWS Standard D17.2 in FIG. 11). It should be understood that weld currents in this range (e.g., 11-14 kA) are common in industrial applications. It should also be understood that welding current can vary depending on the materials and/or thicknesses of metals to be joined.

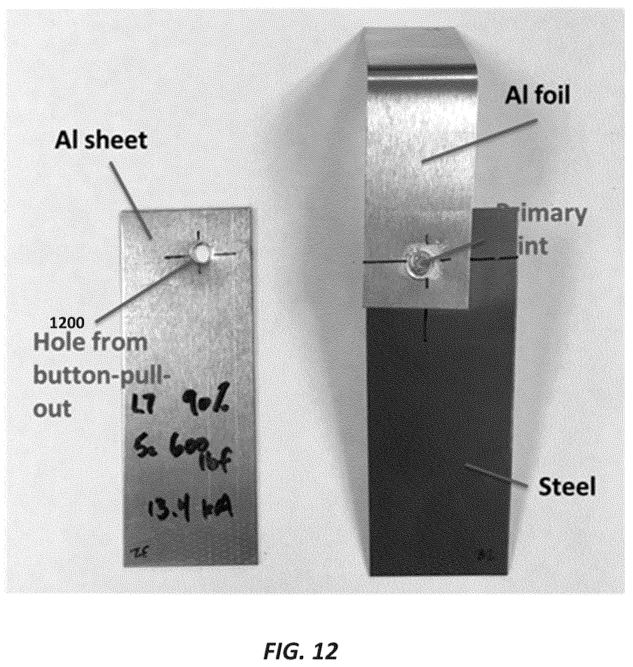

Referring now to FIG. 12, a button-pull-out failure mode (joint strength=3.4 kN) is shown for the primary weld created using the U+RSW process described in U.S. patent application Ser. No. 16/006,903. The hole 1200 from the button-pull-out is also shown in FIG. 12. Button-pull-out failure is a desirable failure mode indicating the soundness and strength of the joint. For comparison, a direct RSW between Al and steel would fail in an interfacial mode at low peak load due to the brittle IMCs present at the interface.

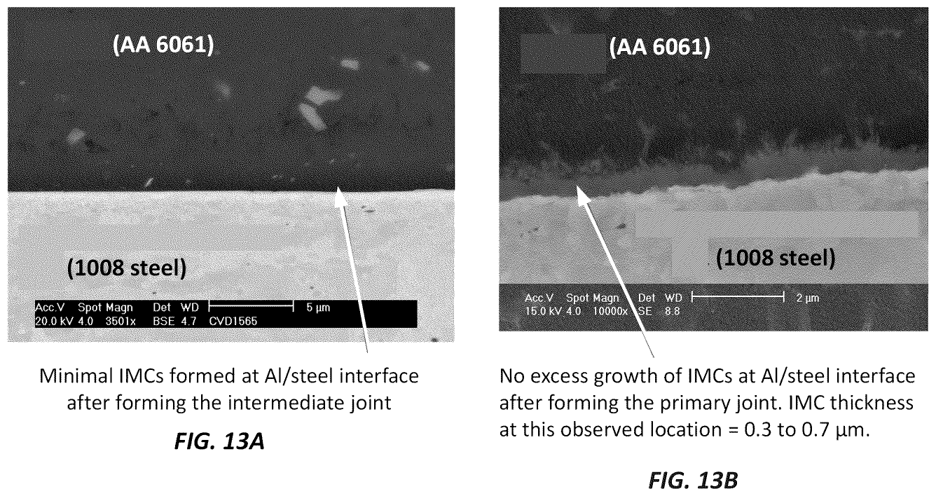

FIG. 13A illustrates IMCs formed at the Al/steel interface after formation of the intermediate joint created using the U+RSW process described in U.S. patent application Ser. No. 16/006,903. FIG. 13B illustrates the microstructure at the Al/steel joint created using the U+RSW process described in U.S. patent application Ser. No. 16/006,903 after forming the primary joint. There is no excess formation of intermetallic compounds (IMCs), which weaken the bond, in FIG. 13B. In particular, the thickness of intermetallic compounds at the interface between the joined metals after formation of the primary joint is sufficiently thin to avoid a detrimental effect on mechanical properties of the primary joint. As shown in FIG. 13B, the thickness of intermetallic components (e.g., FeAl₃, Fe₂Al₅) along the Al/steel interface is less than 2 micrometers (μm), and it is only 0.3 to 0.7 μm at some locations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for joining metals, comprising:
forming an intermediate joint between a light metal member and a metal insert, wherein the intermediate joint is formed using a solid state welding process; and
forming a primary joint between the light metal member and a high-strength steel member, wherein the primary joint is formed using a welding process that melts both the light metal member and the high-strength steel member at a temperature above the respective melting points of the light metal member and the high-strength steel member, wherein the welding process used to form the primary joint melts and fuses together the high-strength steel member and a first local region of the metal insert in contact with the high-strength steel member without melting and fusing together both the light metal member and a second local region of the metal insert in contact with the light metal member, wherein the welding process used to form the primary joint melts the light metal member to braze onto the second local region of the metal insert, and wherein the metal insert prevents a molten portion of the high-strength steel member from mixing with a molten portion of the light metal member.

2. The method of claim 1, wherein the high-strength steel member is aluminized steel.

3. The method of claim 1, wherein the high-strength steel comprises a zinc or aluminum-silicon alloy coating.

4. The method of claim 1, wherein the high-strength steel is press hardened steel.

5. The method of claim 1, wherein the high-strength steel member has a tensile strength of about 1500 MPa.

6. The method of claim 1, wherein the light metal member is aluminum (Al) or an aluminum alloy, magnesium (Mg) or a magnesium alloy, or titanium (Ti) or a titanium alloy.

7. The method of claim 1, wherein the metal insert has a thickness greater than 0.125 millimeter (mm).

8. The method of claim 7, wherein the metal insert has a thickness of about 0.25 mm.

9. The method of claim 1, wherein the primary joint is formed to at least partially overlap with the intermediate joint.

10. The method of claim 1, wherein the intermediate joint is selectively formed at a desired location of the primary joint before forming the primary joint.

11. The method of claim 1, wherein the intermediate joint is a metallurgical bond.

12. The method of claim 1, wherein the solid state welding process used to form the intermediate joint roughens a surface of the metal insert.

13. The method of claim 1, wherein the solid state welding process used to form the intermediate joint is an ultrasonic welding process or an impact welding process.

14. The method of claim 1, wherein the welding process used to form the primary joint is resistance welding, projection welding, or a capacitive discharge welding process.

15. The method of claim 1, wherein the solid state welding process used to form the intermediate joint is an ultrasonic spot welding process, and the welding process used to form the primary joint is resistance spot welding.

16. The method of claim 1, wherein a thickness of intermetallic compounds at the interface between the light metal and high-strength steel members after formation of the primary joint is sufficiently thin to avoid a detrimental effect on mechanical properties of the primary joint.

17. The method of claim 1, wherein a strength of the primary joint is greater than a minimum required by an industry standard.

18. The method of claim 1, further comprising providing a sealant layer between the light metal member and the metal insert before forming the intermediate joint.

19. The method of claim 18, wherein the sealant layer is an adhesive.

20. The method of claim 1, wherein the metal insert is a high melting point metal.
